(19) United States
(12) Patent Application Publication
(10) Pub. No.: US 2026/0126024 A1
(43) Pub. Date: May 7, 2026

(54) All-Terrain Vehicle

(71) Applicant: Zhejiang CFMOTO Power Co., Ltd., Hangzhou (CN)

(72) Inventors: Chen Yang, Hangzhou (CN); Li Guan, Hangzhou (CN); Wenbing Duan, Hangzhou (CN); Jianchong Wang, Hangzhou (CN); Chuanwei Gan, Hangzhou (CN); Jian Wang, Hangzhou (CN)

(21) Appl. No.: 19/436,249

(22) Filed: Dec. 30, 2025

Related U.S. Application Data
(63) Continuation of application No. PCT/CN2024/102709, filed on Jun. 28, 2024.

(30) Foreign Application Priority Data
Jun. 30, 2023 (CN) 202310801973.4

(51) Int. Cl. F02M 35/10; F01M 1/16; F01M 11/02; F01N 13/10; F01P 3/02

(52) U.S. Cl. CPC F02M 35/10268; F01M 1/16; F01M 11/02; F01N 13/10; F01P 3/02; F02M 35/10157; F02M 35/10236; F01M 2011/022; F01P 2003/021

(57) ABSTRACT

An air intake system having a turbocharger and an intercooler provides combustion air for an internal combustion engine of an all-terrain vehicle. The all-terrain vehicle includes a straddle seat, and the he intercooler is mounted above the internal combustion engine. The intercooler has a plurality of pressurized air crosspipes defining an intercooler plane. An intercooler attack angle of the intercooler plane relative to horizontal is greater than or equal to 80° and less than 90°. The air intake system includes an intake pressure relief system with a pressure sensor and a pressure relief valve. When the pressure sensor senses an onset of an overpressure event, the pressure relief valve is opened. The turbocharger housing is integrally formed with the exhaust manifold, and the exhaust manifold has flange gaps between exhaust intake ports, which allow thermal expansion difference between the cylinder head and the exhaust manifold.

### RELATED APPLICATION INFORMATION

This application is a continuation of PCT/CN2024/102709, filed Jun. 28, 2024 and entitled “All-Terrain Vehicle”, and claims the benefit of priority to Chinese Patent Application No. 202310801973.4, entitled “all-terrain vehicle”, filed with the Chinese Patent Office on Jun. 30, 2025. The entire contents of the above-referenced application are incorporated herein by reference.

### FIELD OF THE DISCLOSURE

The present invention relates to the field of vehicles, and particularly to an all-terrain vehicle.

### BACKGROUND OF THE DISCLOSURE

In existing technology, as an outdoor vehicle, all-terrain vehicles need to adapt to different scenarios and complex operating conditions. Engines of all-terrain vehicles are required to possess a substantially high power capacity and high power output. For an internal combustion engine, high power output means a large intake air volume and a correspondingly large exhaust volume. While improvements have been made, how to make the structure of all-terrain vehicles equipped with high-power engines compact is a problem that still needs further solutions.

### SUMMARY OF THE INVENTION

The present invention provides an all-terrain vehicle to solve at least one problem existing in the background.

In a first aspect, the present invention provides an all-terrain vehicle including a frame, a body cover, at least four wheels, a prime mover assembly, and an air intake system. The body cover is at least partially arranged on the frame. The four wheels support the frame. The prime mover assembly is supported on the frame and configured to drive the wheels to rotate for locomotion of the all-terrain vehicle. The prime mover assembly has an internal combustion engine. The air intake system provides combustion air for the internal combustion engine. The air intake system has a turborcharger and an intercooler. The turbocharge pressurizes air which causes air heating. The intercooler which cools pressurized air from the turbocharger and provides pressurized, cooled air for combustion. The intercooler has a plurality of pressurized air crosspipes defining an intercooler plane. An intercooler attack angle of the intercooler plane relative to horizontal is greater than or equal to 80° and less than 90°.

In another aspect, the body cover includes a straddle seat. The intercooler is mounted above the internal combustion engine.

In a third aspect, the air intake system includes an intake pressure relief system. The intake pressure relief system has a pressure sensor and a pressure relief valve. When the pressure sensor senses an onset of an overpressure event, the pressure relief valve is opened.

In a fourth aspect, the turbocharger has a turbocharger housing with a turbine and a compressor therein. The turbine is driven by exhaust from the internal combustion engine. The compressor is driven by the turbine to compress air for combustion. The engine includes a plurality of cylinders and a cylinder head. The all-terrain vehicle includes an exhaust system with an exhaust manifold. The turbocharger housing is integrally formed with the exhaust manifold, which is bolted to the cylinder head. The exhaust manifold has flange gaps between exhaust intake ports. The flange gaps allow thermal expansion difference between the cylinder head and the exhaust manifold.

Compared with related vehicles, the all-terrain vehicles of the present invention have increased engine power with a more compact structure through improvements in engine, air intake and exhaust layout and function.

The details of one or more embodiments of the present application are presented in the following figures and description to make other features, objectives, and advantages of the present application more concise and understandable.

### BRIEF DESCRIPTION OF THE DRAWINGS

FIG. 1 is a front left perspective view of an all-terrain vehicle (“ATV”) of the present invention;

FIG. 2 is a front left perspective view of a prime mover assembly of the present invention for use in the ATV of FIG. 1;

FIG. 3 is a front left exploded view of the engine in the prime mover assembly of FIG. 2 and ATV of FIG. 1;

FIG. 4 is a front right perspective view of the engine of FIGS. 2 and 3, and also showing the turbocharger, throttle assembly and intake manifold of the air intake system;

FIG. 5 is a front left perspective view of the engine block of the engine of FIGS. 2-4;

FIG. 6 is a logic diagram of the knock sensor logic used for the engine block of FIGS. 2-5;

FIG. 7 is a top plan view of the engine block of FIG. 5;

FIG. 8 is a cross-sectional view of the engine block of FIGS. 5 and 7, taken along cut line 8-8 of FIG. 7;

FIG. 9 is a cross-sectional view of the cylinder head of FIGS. 3 and 4, also showing the oil delivery passage through the engine block of FIGS. 3 and 4;

FIG. 10 is an enlarged view of section 10 of FIG. 9;

FIG. 11 is a perspective view of the oil flowrate control bolt of FIGS. 9 and 10;

FIG. 12 is a perspective view of an intake resonance plenum and alternative air filter for use with the air intake system of the ATV of FIG. 1;

FIG. 13 is view of the intake resonance plenum and air filter of FIG. 12, taken in cross-section through a center line of the intake resonance plenum and also cutting through the turbocharger air intake duct;

FIG. 14 is a perspective view of a second alternative air filter for use with the air intake system of the ATV of FIG. 1, also showing the turbocharger air intake duct;

FIG. 15 is an exploded perspective view of the air filter of FIG. 14, again showing the turbocharger air intake duct;

FIG. 16 is a rear right perspective view of a cylinder head, cylinder head cover, exhaust manifold and turbocharger for use with the engine of FIGS. 2-4;

FIG. 17 is a rear perspective view of the exhaust manifold and turbocharger of FIG. 16;

FIG. 18 is a front view of an intercooler for use with the engine of FIGS. 2-4;

FIG. 19 is a cross-sectional view through the intercooler of FIG. 18.

FIG. 20 is a front perspective view of the turbocharger of FIGS. 16 and 17 and the intercooler of FIGS. 18 and 19 with an air filter, pressure relief system, throttle assembly and intake manifold on a cylinder head.

FIG. 21 is a schematic of the air intake system shown in FIG. 20 and exhaust system used in the ATV of FIG. 1;

FIG. 22 is a front left perspective view of an intake manifold for use in the ATV of FIG. 1;

FIG. 23 is a bottom view of the intake manifold of FIG. 22;

FIG. 24 is a cross-sectional view of the intake manifold of FIGS. 22 and 23, taken along cut lines 24-24 of FIG. 22;

FIG. 25 is a bottom perspective view of an alternative exhaust manifold for use in the ATV of FIG. 1;

FIG. 26 is a rear left perspective view of the frame, prime mover assembly, air intake system and exhaust system of the ATV of FIG. 1;

FIG. 27 is a rear view of the muffler and exhaust pipe of FIG. 26; and

FIG. 28 is an exploded view of the muffler and exhaust pipe of FIG. 27.

### DETAILED DESCRIPTION

For better understanding of the above objects, features and advantages of the present invention, preferred embodiments will be described in detail below with reference to the accompanying drawings. It should be understood that for those skilled in the art, improvements or transformations can be made based on the above description, and all such improvements and transformations should fall within the scope of protection of the attached claims.

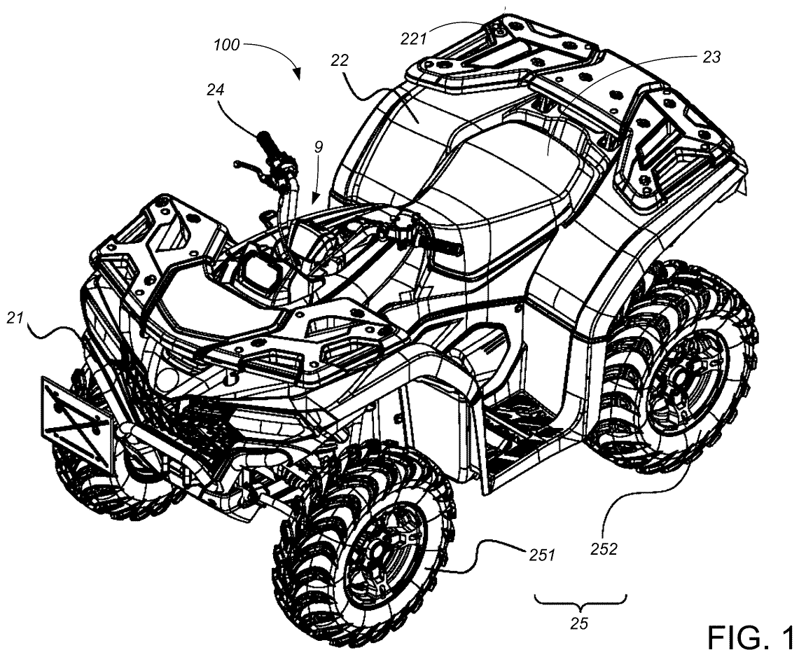

As shown in FIGS. 1 to 3, the present invention involves an all-terrain vehicle 100 (“ATV”) having an internal combustion engine 1 provided as part of a prime mover assembly 10. The ATV 100 includes a frame 21, a body cover 22 preferably including a rear cargo platform 221, a straddle seat 23, a steering system 24 and four wheels 25. The prime mover assembly 10 is at least partially arranged on the frame 21, and at least two and more preferably all four wheels 25 are in transmission connection with the prime mover assembly 10 through a drive train (not shown) providing torque such that the four wheels 25 provide locomotion for the ATV 100 to travel. The wheels 25 include two front wheels 251 and two rear wheels 252. The steering system 24 controls the steering orientation of the front wheels 251 so a driver can control the traveling direction of the ATV 100. The driver sits on the straddle seat 23 during operation of the ATV 100, and the engine 1 is preferably located under the straddle seat 23 and/or between the driver's legs.

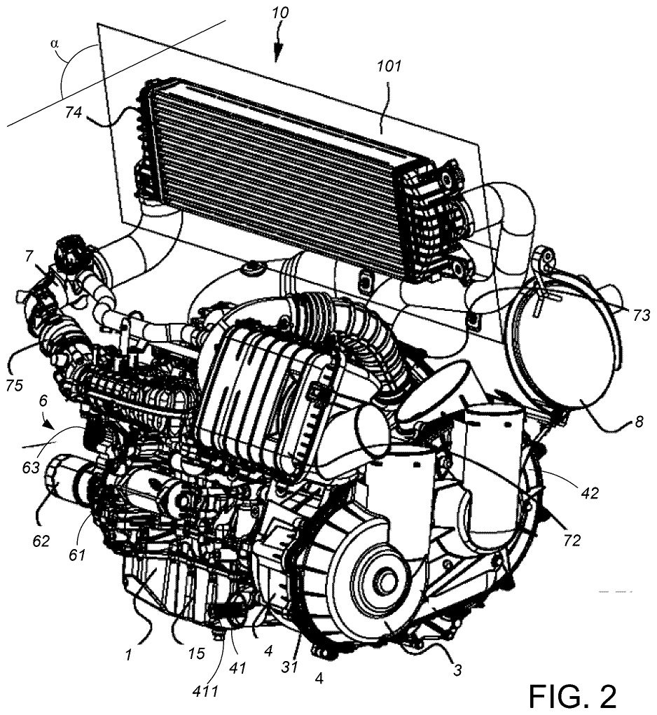

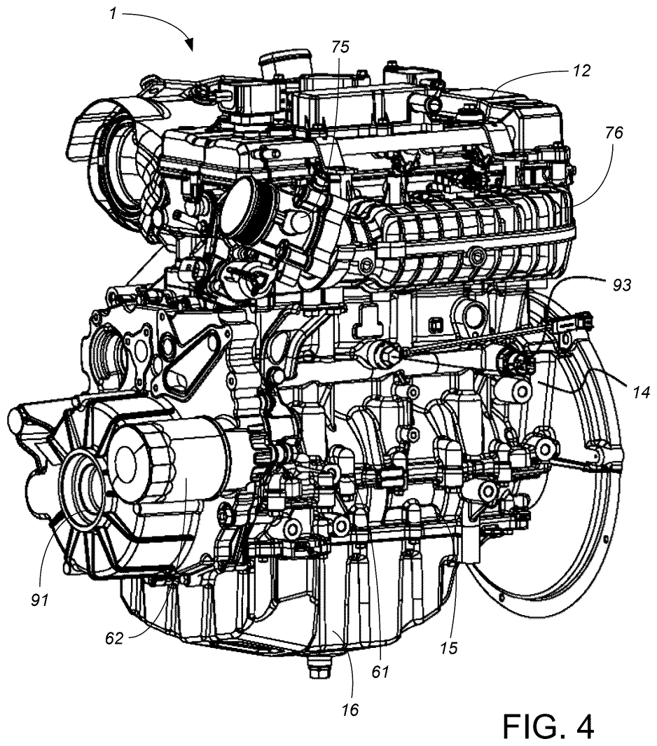

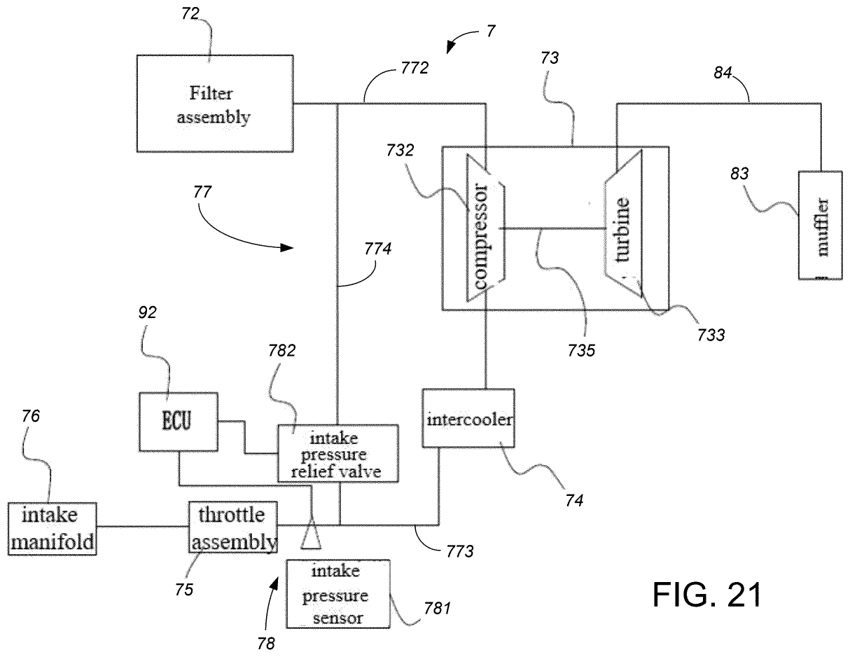

As shown in FIG. 2, in addition to the engine 1, the prime mover assembly 10 further includes a transmission 3 which is preferably a continuously variable transmission (“CVT”) and a gearbox 4. The CVT 3 is configured to transmit the torque of the engine 1 to the gearbox 4. The gearbox 4 transmits torque based on gear selection, such as forward, reverse, neutral, park, etc. The preferred gearbox 4 is relatively tall and narrow, outputting torque for the front wheels 251 on a front splined end 411 of a front delivery shaft 41 and for the rear wheels 252 on an integrated, direct-drive rear differential 42. A cooling system 5 (shown only in small part in FIG. 4, further shown in FIG. 23) is provided to help remove heat from the engine 1. A lubrication system 6 is provided to lubricate moving parts of the engine 1. An air intake system 7 provides at least combustion air to the engine 1. An exhaust system 8 expels exhaust gas from the engine 1. The ATV 100 also includes an electrical system 9 generally called out in FIG. 1, which includes at least an alternator 91 (called out in FIG. ?) driven by the engine 1 to provide electricity to a battery (not shown) and an electronic control unit (“ECU”) 92 (called out in FIG. 21), as well as various other electrical components of the ATV 100.

The engine 1 is shown in exploded view in FIG. 4, separating generally stationary housing portions 12-16 from the generally moving and operational portions 17. Specifically, from top to bottom the engine 1 includes a cylinder head cover 12, a cylinder head 13, an engine block 14, a crankcase 15 and an oil pan 16. The cylinder head 13 is at least partially arranged between the cylinder head cover 12 and the engine block 14, connecting the cylinder head cover 12 to the engine block 14. The crankcase 15 is at least partially arranged between the engine block 14 and the oil pan 16, connecting the oil pan 16 to the engine block 14. An end of the crankshaft 11 extends laterally beyond the edges of the engine block 14 and crankcase 15 and through the inside cover 31 of the CVT 3, so the crankshaft 11 transmits torque directly to the interior components (not shown) of the CVT 3.

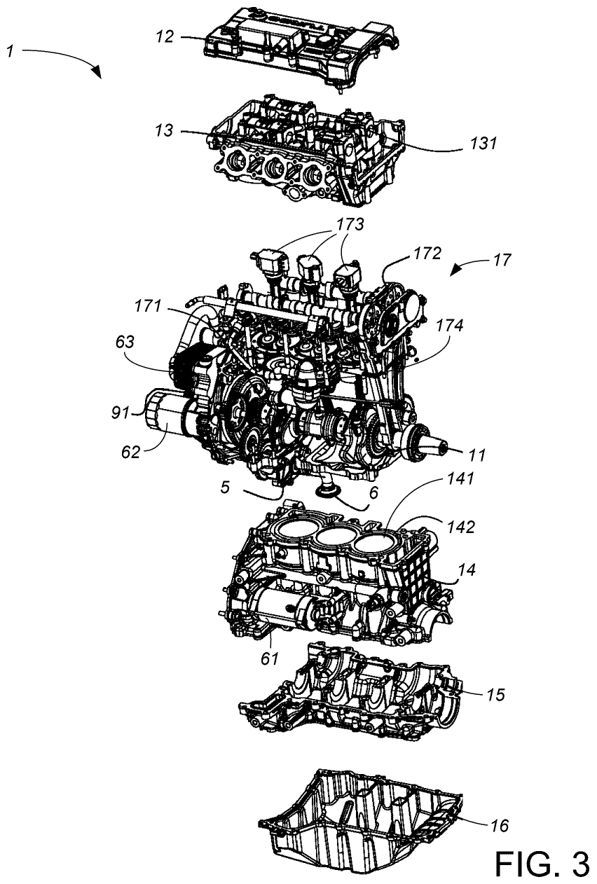

In the preferred embodiment depicted and as best shown in FIG. 3, the engine block 14 defines three cylinders 141. Valves 171 for each cylinder 141 are mounted in the cylinder head 13. The reciprocating position of each valve 171 is controlled by one or more preferably two cam shafts 172, to control introduction of air and expelling of exhaust gas from each cylinder 141. A fuel injector 173 is preferably also provided for each cylinder 141, to control introduction of fuel to each cylinder 141 mixed with air for combustion. A piston 174 moves reciprocally in each cylinder 141, with each piston 174 linked to the crankshaft 11 to cause rotation of the crankshaft 11.

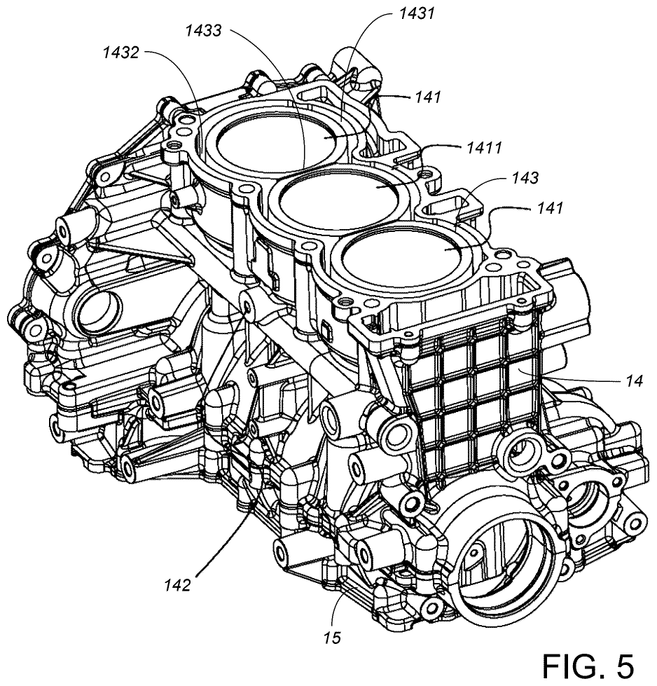

The preferred engine block 14 includes a knock sensor 93 best understood with reference to FIGS. 4-6. The knock sensor 93 is used to monitor vibration, thereby allowing assessment of combustion status of gases in the engine 1. Specifically, during running the engine block 14 will generate vibration waves of different frequencies. The knock sensor 93 will recognize the vibration waves and convert them into an electrical signal, transmitting the electrical signal to the ECU 92. The knock sensor 93 is mounted on the engine block 14 with a knock sensor mounting seat 142, which is preferably positioned on the middle cylinder 1411, at a mid elevation of the engine block 14 and on the air intake side of the engine block 14. The knock sensor mounting seat 142 extends away from a center line of the middle cylinder 1411. The preferred location of the knock sensor mounting seat 142 arranges the knock sensor 93 in a relatively lower temperature area, so the knock sensor 93 has better longevity and reliability. In addition, positioning the knock sensor 93 on the middle cylinder 1411 helps make the signal received by the knock sensor 93 more uniform and indicative of combustion situation of all three cylinders 141.

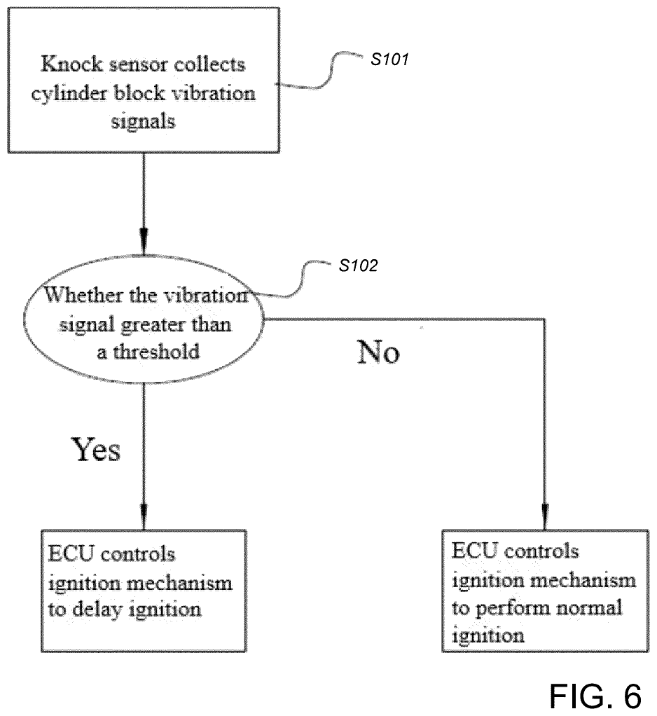

Use of the knock sensor 93 follows a method as shown in FIG. 6. The knock sensor 93 is designed to be sensitive to one or more specific frequencies of engine knock, filtering out normal engine noise. Thus, in a first step S101, the knock sensor 93 collects vibration signals from the engine block 14. In a second step S102, the knock sensor 93 senses whether vibration magnitude within a set frequency range is above a timing-adjustment threshold value. If so, (i.e., when the knock sensor signal indicates excessive knock), the knock sensor 93 sends an electrical signal to the ECU 92, and the ECU 92 will delay ignition timing (rotational angle of the cam shafts 172 to spark ignition) based on the electrical signal to improve combustion. When combustion improves such that the knock sensor 93 detects acceptable vibration (vibration magnitude within the set frequency range below a return-to-normal threshold value, which may be the same as or lower than the timing-adjustment threshold value), the ECU 92 will control the ignition timing to return to normal timing, thereby achieving better combustion effect.

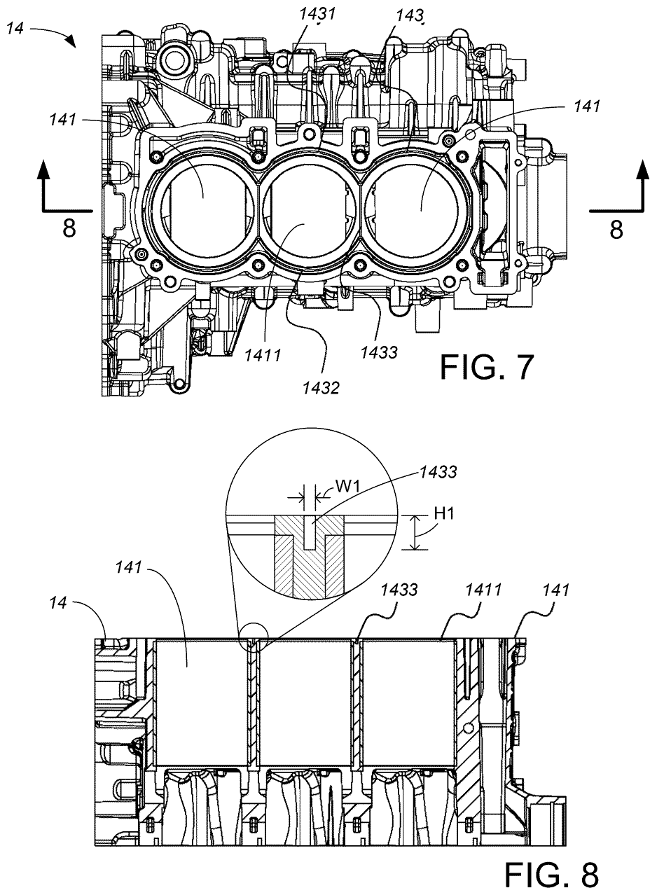

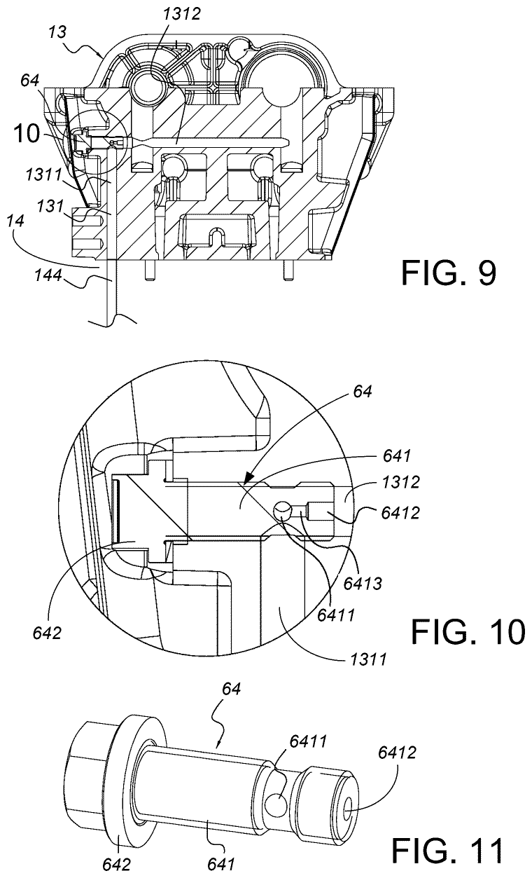

The cooling system 5 circulates coolant through the engine 1 to take away the heat generated by the engine 1 during operation. The cooling system 5 includes a pump 51 (referred to as a “water pump”, even though the coolant may be antifreeze or the like rather than water). As shown in FIGS. 7 and 8, the engine block 14 defines a cylinder water jacket 143 which at least partially surrounds each combustion chamber/cylinder 141 for coolant to flow through the engine 1. The cylinder water jacket 143 includes an exhaust-side path 1431 and an intake-side path 1432. The engine block 14 is not necessarily a completely symmetrical component, and coolant does not flow in a completely symmetrical manner between the exhaust-side path 1431 and the intake-side path 1432, resulting in a pressure difference between the exhaust-side path 1431 and the intake-side path 1432. As best shown in FIG. 8, the preferred cooling system 5 has two longitudinal coolant flow channels 1433 (“longitudinal” relative to the ATV 100) connecting the exhaust-side path 1431 and the intake-side path 1432. The pressure difference between the exhaust-side path 1431 and the intake-side path 1432 causes coolant to flow through one or both longitudinal coolant flow channels 1433, helping take away the heat from the engine block 14 adjacent to the longitudinal coolant flow channels 1433 and optimizing the cooling effect. The preferred embodiment has the longitudinal coolant flow channels 1433 provided as grooves in the top of the engine block 14, but other embodiments provide the longitudinal coolant flow channels as through-holes in the engine block 14 extending between cylinders 141. Each coolant flow channel 1433 has a channel width W1 which is preferably greater than or equal to 1 mm and less than or equal to 2 mm, more preferably greater than or equal to 1.2 mm and less than or equal to 1.8 mm, and most preferably greater than or equal to 1.4 mm and less than or equal to 1.6 mm. Each coolant flow channel 1433 has a channel height H1 which is preferably greater than or equal to 3 mm and less than or equal to 7 mm, more preferably greater than or equal to 4 mm and less than or equal to 6 mm, and most preferably greater than or equal to 4.5 mm and less than or equal to 5.5 mm. By having channel dimensions W1, H1 within these ranges, heat dissipation efficiency of the cooling system 5 is increased while maintaining strength of the engine block 1113. Due to the pressure difference between the exhaust-side path 1431 and the intake-side path 1432, coolant maintains longitudinal flow through the longitudinal coolant flow channels 1433.

The lubrication system 6 includes an oil pump 61 driven by the crankshaft 11 as well as an oil filter 62 and an oil cooler 63. The oil pump 61 pumps engine oil from the oil pan 16 through the oil filter 62 and oil cooler 63 and then through one or more oil delivery passages 131, 144 for spray lubrication of moving components of the engine 1. The preferred oil delivery passages 131, 144 include a head oil delivery passage 131 through the cylinder head 13 as shown in FIG. #, with a block oil delivery passage 144 extending vertically within the engine block 14 delivering oil from the oil cooler 63 on its way up to the head oil delivery passage 131. The head oil delivery passage 131 includes a vertical oil delivery passage leg 1311 in fluid communication with at least one generally horizontal oil delivery passage leg 1312. An oil flowrate control bolt 64 is preferably positioned at the junction of the vertical and generally horizontal oil delivery passage legs 1311, 1312. In the preferred manufacturing process, both the vertical and generally horizontal oil delivery passage legs 1311, 1312 are drilled into the metal structure of the cylinder head 13, and the oil flowrate control bolt 64 preferably closes off the drill hole through the side of the cylinder head 13 used to form the generally horizontal oil delivery passage leg 1312. This method can reduce the manufacturing cost of the engine 1, and the assembly of oil flowrate control bolt 64 into the cylinder head 13 is simple and convenient.

The inner diameters of the vertical oil delivery passage leg 1311 and the generally horizontal oil delivery passage leg 1312 are different, thereby resulting in different oil flow velocities in the vertical oil delivery passage leg 1311 and the generally horizontal oil delivery passage leg 1312.

The oil flowrate control bolt 64 is better shown in FIGS. 10 and 11. The oil flowrate control bolt 64 can both close part of the head oil delivery passage 131 and thereby change the oil flowrate. The bolt 64 has an externally threaded shaft 641 which mates with internal threads on the head oil delivery passage 131 and a head 642. The head 642 is preferably hexagonal to allow turning with a hexagonal socket (not shown), but alternatively could be an Allen head or a screw head for a flat or Phillips screwdriver. The shaft 641 has a transverse hole 6411 with at least one side entrance, and the transverse hole 6411 is in fluid communication with a shaft channel 6412 through an oil throttling throat 6413. The diameter of the oil throttling throat 6413 is smaller than the diameter of the transverse hole 6411 and smaller than the diameter of the shaft channel 6412, all of which are smaller than diameters of the vertical and generally horizontal oil delivery passages 1311, 1312, so the oil flowrate control bolt 64 performs the function of oil flow rate throttling.

The engine 1 is arranged transversely, that is, the crankshaft 11 extends basically along a left-right direction on the ATV 100. The preferred embodiment places the CVT 3 on the left end of the crankshaft 11 and the oil pump 61 and the alternator 91 on the right end of the crankshaft 11, but this left to right orientation can be easily reversed.

The air intake system 7 includes an intake resonance plenum 71, an air filter 72, a turbocharger 73, an intercooler 74, a throttle assembly 75 and an intake manifold 76, all connected consecutively through ducts 77 to transmit air from one component to the next. The intake resonance plenum 71 is used to decrease noise of the engine 1 while also removing particulates from the incoming air. The air filter 72 is used to further clean the incoming air, removing dust, moisture and smaller impurities. The turbocharger 73 uses exhaust gas to pressurize incoming combustion air, increasing turbulence intensity. The intercooler 74 cools air compressed by the turbocharger 73 prior to regulation of air flow rate by the throttle assembly 75 and introduction of the cooled, pressurized, regulated air through the valves 171 into the cylinders 141 through the intake manifold 76 and cylinder head 13. The intake manifold 76 is preferably positioned at the front side of the cylinders 141 fixedly connected to the cylinder head 13.

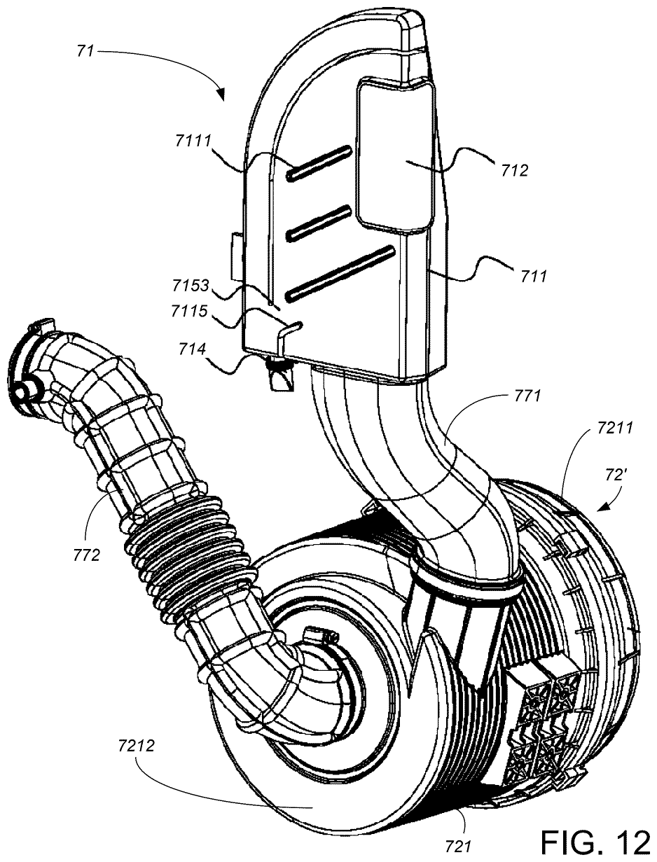

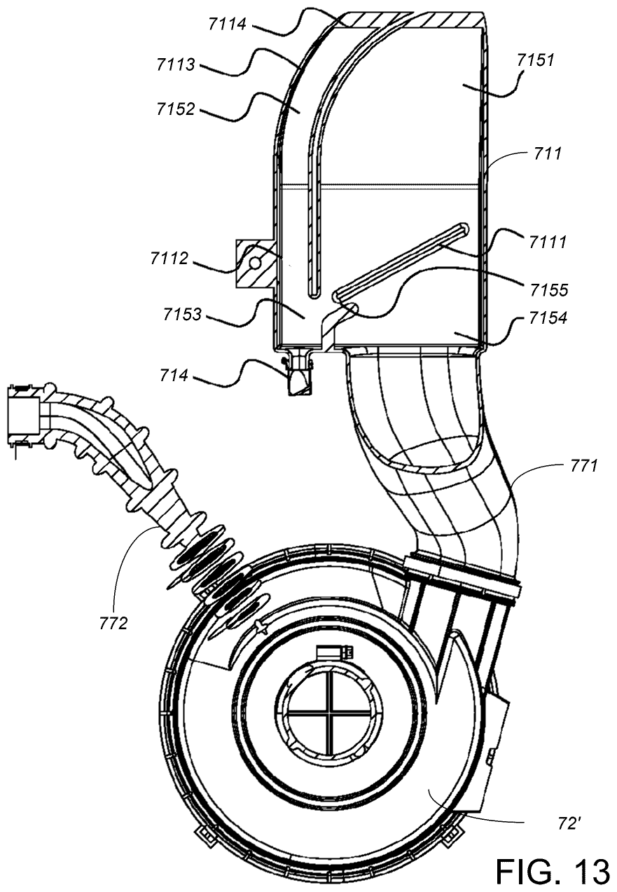

The preferred intake resonance plenum 71 is shown in FIGS. 12 and 13. The intake resonance plenum 71 includes a plenum housing 711 with an upper side inlet port 712 and a bottom side outlet port 713. A particulate discharge 714 is positioned on the plenum housing 711 adjacent the bottom side outlet port 713. One or more reinforcement ribs 7111 are molded into the plenum housing 711 for enhancing the strength of the plenum housing 711. The reinforcement ribs 7111 are preferably arranged between the inlet port 712 and the particulate discharge 714, and the reinforcement ribs 7111 substantially extend in the direction from the inlet port 712 to the particulate discharge 714.

The interior of the plenum housing 711 is shown in FIG. 13, and includes a stabilization chamber 7151, a quarter-wavelength chamber 7152, a particulate drop curve 7153, and an output chamber 7154. The quarter wavelength chamber 7152 is used to reduce noise, and is defined by a lower straight wall 7112, an upper arc-shaped transition wall 7113 and an echo wall 7114. The lower straight wall 7112, the upper arc-shaped transition wall 7113 and the echo wall 7114 facilitate refraction of sound waves in the quarter wavelength chamber 7152, thereby improving noise interference and enhancing the comfort of the ATV 100. The length of the quarter-wavelength chamber 7152 is selected based upon characteristic frequency of engine sound. Sound waves are reflected at the echo wall 7114, cancelling out sound waves with the same characteristic frequency being at opposite phase at the entrance to the quarter wavelength chamber 7152, achieving the purpose of noise reduction.

One or more of the reinforcement ribs 7111 at least partially extend into the stabilization chamber 7151, and after air enters the interior of the stabilization chamber 7151 through the inlet port 712, the reinforcement ribs 7111 also help guide the air toward the particulate discharge 714. The reinforcement ribs 7111 help guide both air transmission and sound wave conduction, thereby facilitating the introduction of sound waves into the quarter wavelength chamber 7152 and improving its noise reduction performance. Impurities such as dust and moisture in the air separate from the air flow at the particulate drop curve 7153. Particulate matter can be discharged from the intake resonance plenum 71 through the particulate discharge 714, thereby reducing the workload of the air filter 72. A guide wall 7115 is arranged in the intake resonance plenum 71 below the quarter wavelength chamber 7152. The preferred guide wall 7115 extends upwardly and then is inclined outwardly relative to the particulate discharge 714 to help define the particulate drop curve 7153. A gap 7155 is defined between the reinforcement ribs 7111 and the guide wall 7115. The guide wall 7115 thus helps define the particulate drop curve 7153 and provides a location for particulate to gather until the accumulated particulate can be removed from the intake resonance plenum 71 out of the particulate discharge 714. After the air passes through the particulate drop curve 7153 to remove impurities, it flows through the gap 7155 into the output space 7154, and subsequently flows through an air filter inlet duct 771 to the air filter 72.

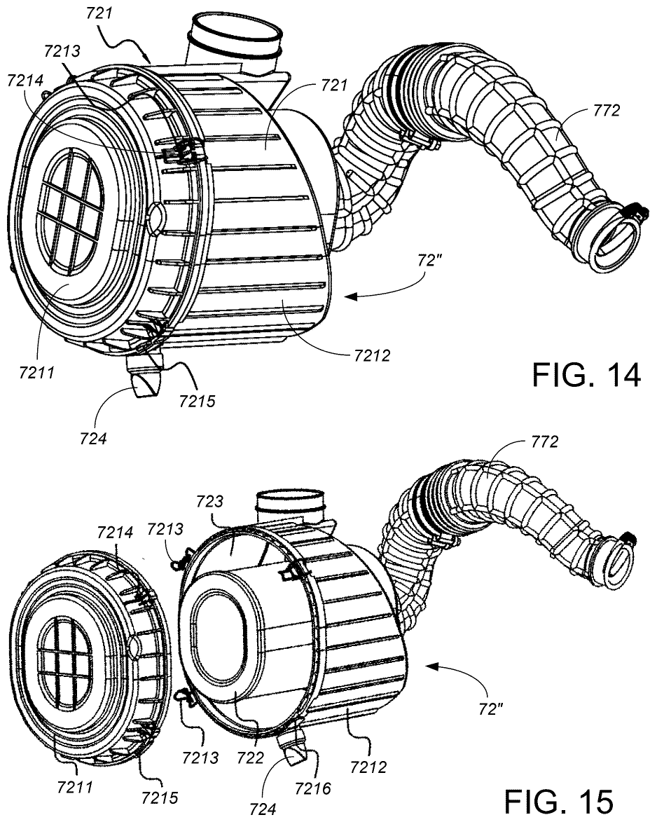

The air filter 72 includes an air filter housing 721 around an air filter element 722. A first embodiment of the air filter 72 is shown in FIG. 2, a second embodiment of the air filter 72′ is shown in FIGS. 12 and 13, and a third embodiment of the air filter 72″ is shown in FIGS. 14 and 15, with the difference being the external shapes of the air filter housing 721 and air filter element 722. The air filter housing 721 includes an air filter housing cover 7211 detachably and/or movably secured to an air filter housing body 7212. The air filter inlet duct 771 provides air from the intake resonance plenum 71 on an outer side 723 of the filter element 722, which air passes through the filter element 722 to filter out dust and other impurities in the air. In the preferred embodiment shown in FIGS. 14 and 15, an air filter particulate discharge 724 is provided on a bottom of the air filter housing body 7212, for removing accumulated matter from the air filter housing body 7212 without removing the air filter housing cover 7211 from the air filter housing body 7212. The detachable and/or movable connection between the air filter housing cover 7211 and the air filter housing body 7212 allows the filter element 722 to be removed and replaced at regular maintenance intervals.

The air filter housing cover 7211 is preferably removably attached to the air filter housing body 7212 with a plurality of buckles 7213 hingedly mounted on the air filter housing body 7212, and which can loop around buckle receiving hooks 7214 on the air filter housing cover 7211. The buckles 7213 are preferably at least partially positioned in a blind spot and/or out of the line of sight so as to be less intrusive. The air filter housing 721 also includes one or more limit keys 7215 mating into corresponding limit holes 7216 after assembly, which further hold and position the air filter housing cover 7211 relative to the air filter housing body 7212. The combination of buckles/hooks 7213/7214 and limit keys/holes 7215/7216 facilitate connection between the air filter housing cover 7211 and the air filter housing body 7212, improving the convenience and accuracy of the assembly and maintenance of the air filter 72.

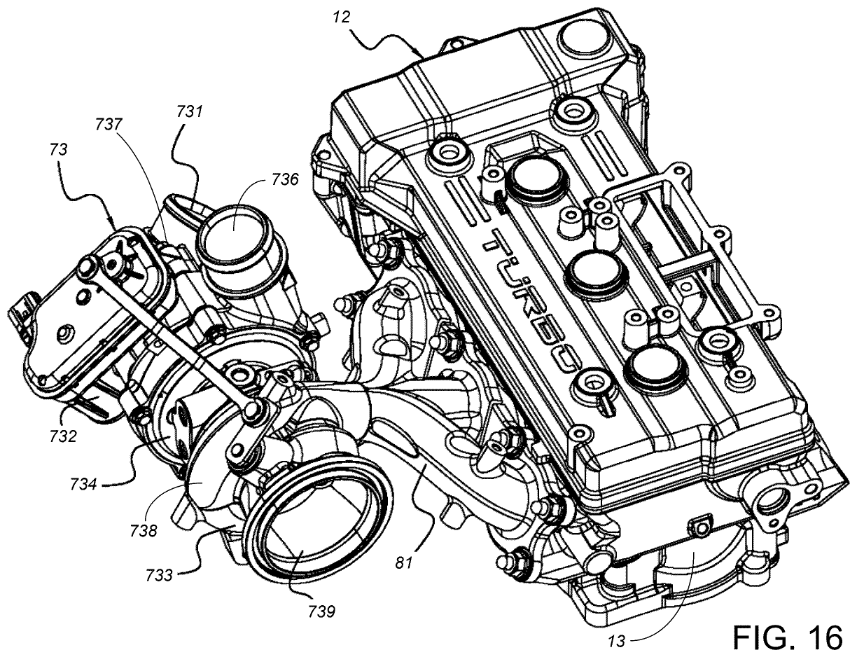

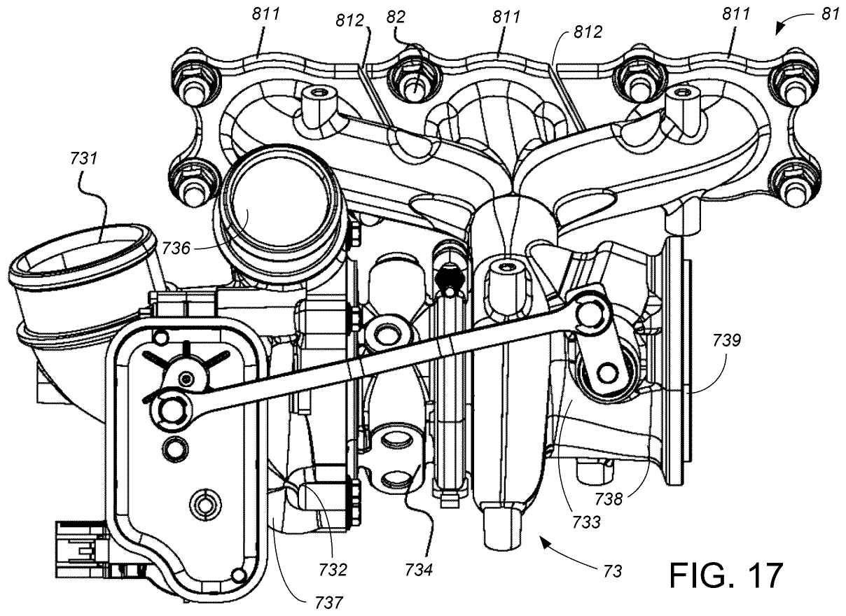

After passing through the air filter 72, the air flows through a turbocharger air inlet duct 772 to the turbocharger 73, and the preferred turbocharger 73 is further explained with reference to FIGS. 16 and 17. The turbocharger 73 includes a turbocharger air inlet port 731 attached to the turbocharger inlet duct 772. The turbocharger 73 includes a compressor 732 and a turbine 733 both positioned within a turbocharger housing 734. The turbine 733 is in fluid communication with an exhaust manifold 81 and the exhaust gas drives the turbine 733 to rotate. The turbine 733 and the compressor 732 share a common drive shaft 735 (shown only in FIG. 21), and the turbine 733 transmits power to the compressor 732 by the drive shaft 735 to drive the compressor 732. The compressor 732 operates to compress air received from the air filter 72, outputting air through a compressed air outlet port 736 for subsequent use in combustion. The turbocharger 73 thus has an air handling side 737 and an exhaust handling side 738.

In the embodiment shown in FIGS. 16 and 17, the turbocharger housing 734 is integrally formed with the exhaust manifold 81, allowing reduced size and easier mounting of the turbocharger 73. The turbocharger 73 has a turbocharger exhaust outlet port 739 for subsequent handling of exhaust gas after it has driven through the turbine 733.

The exhaust manifold 81 has three exhaust intake ports 811 for connection to the cylinder head 13, one for receiving exhaust gas output by each cylinder 141. The exhaust manifold 81 is preferably formed of a different material than the material used for the cylinder head 13. In particular, the material of the exhaust manifold 81 differs from the material of the cylinder head 13 in terms of specific heat capacity and thermal expansion coefficient. Due to their handling of exhaust gas, the cylinder head 13 and the exhaust manifold 81 have working temperature ranges from freezing ambient temperatures (such as down to −40° C. in cold climates) to up to 700-900° C. The preferred exhaust manifold 81 has flange gaps 812 defined between adjacent intake ports 811. The flange gaps 812 can absorb different thermal expansion of the exhaust manifold 81 relative to the cylinder head 13, thereby avoiding excessive shear forces on attachment bolts 82. The flange gaps 812 help the attachment bolts 82 avoid loosening due to thermal cycling and help avoid air leakage between the exhaust manifold 81 and the cylinder head 13, which would otherwise affect the service life of the entire engine 1. The flange gaps 812 are preferably greater than or equal to 3 mm and less than or equal to 5 mm in width, more preferably greater than or equal to 3.5 mm and less than or equal to 4.5 mm in width, and most preferably greater than or equal to 3.8 mm and less than or equal to 4.2 mm in width. Through such arrangement, it can be ensured that the connection between the exhaust manifold 81 and the cylinder head 13 can absorb material deformation caused by high temperature differences, while avoiding excessive clearance and stress concentration on the attachment bolts 82, and avoiding engine damage.

The turbocharger 73 preferably makes the full speed air consumption of the engine 1 to be greater than or equal to 650 kg/h and less than or equal to 750 kg/h, and most preferably about 726 kg/h. At such full speed air consumption, fuel consumption of the engine 1 reaches 70 kg/h, the rotational speed of the crankshaft 11 of the engine 1 is greater than or equal to 8000 r/min and less than or equal to 9000 r/min, and the power per liter of the engine 1 is greater than or equal to 150 kW/L and less than or equal to 160 kW/L. The engine 1 thus outputs a strong driving force, and the ATV 100 equipped with the engine 1 is powerful and is able to adapt to complex road conditions.

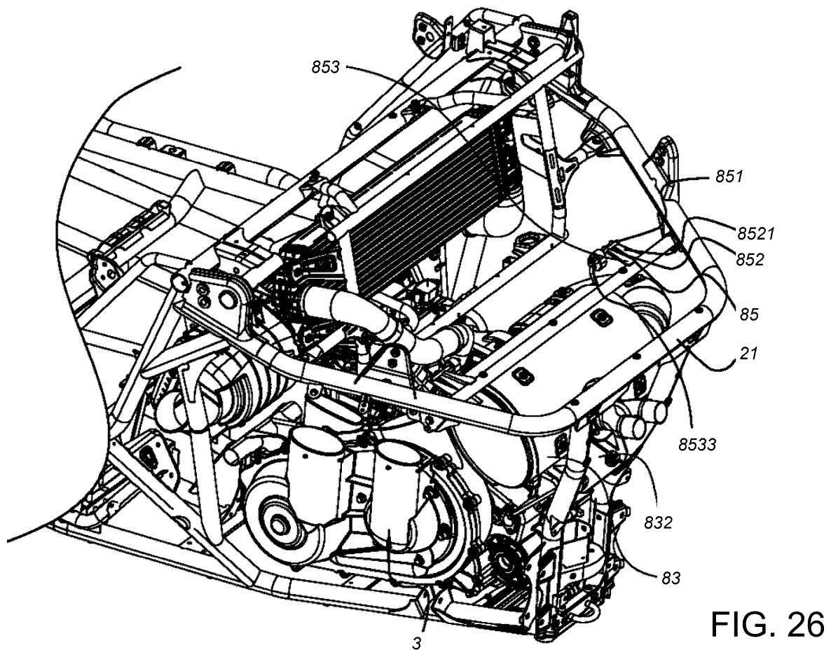

The intercooler 74 is preferably mounted substantially above the engine 1 and above the turbocharger 73 in the position shown in FIGS. 2 and 26. While alternative embodiments use a liquid-cooled intercooler, the preferred intercooler 74 is air cooled. In the intercooler position shown in FIGS. 2 and 26, air flow through the intercooler 74 during driving of the ATV 100 may not be entirely horizontal, but instead may be affected by the slipstream of airflow around the vehicle 100. In particular, the preferred location of the intercooler 74, during high speed driving of the ATV 100, results in an airflow through the intercooler 74 which is slightly upwardly directed.

The outer surface of the intercooler 74 is an irregular surface, but as a whole defines an intercooler plane 101. The intercooler 74 is mounted with its intercooler plane 101 adjusted out-of-entirely-vertical in accordance with the high speed air flow through the intercooler 74 on the particular ATV shape, in the preferred embodiment with a top of the intercooler 74 further forward than a bottom of the intercooler 74. An intercooler attack angle α is defined between the intercooler plane 101 and horizontal. The intercooler attack angle α is preferably greater than or equal to 80° and less than 90° degrees, and more preferably about 85°. By this arrangement, the upwardly oriented windward effect of the intercooler 74 during high speed driving can be optimized, thereby resulting in better cooling effect and a more compact structure of the entire prime mover assembly 10. Alternatively, if the intercooler is liquid cooled, then the mounting orientation of the intercooler plane 101 relative to ambient air flow while the ATV 100 is moving becomes largely irrelevant.

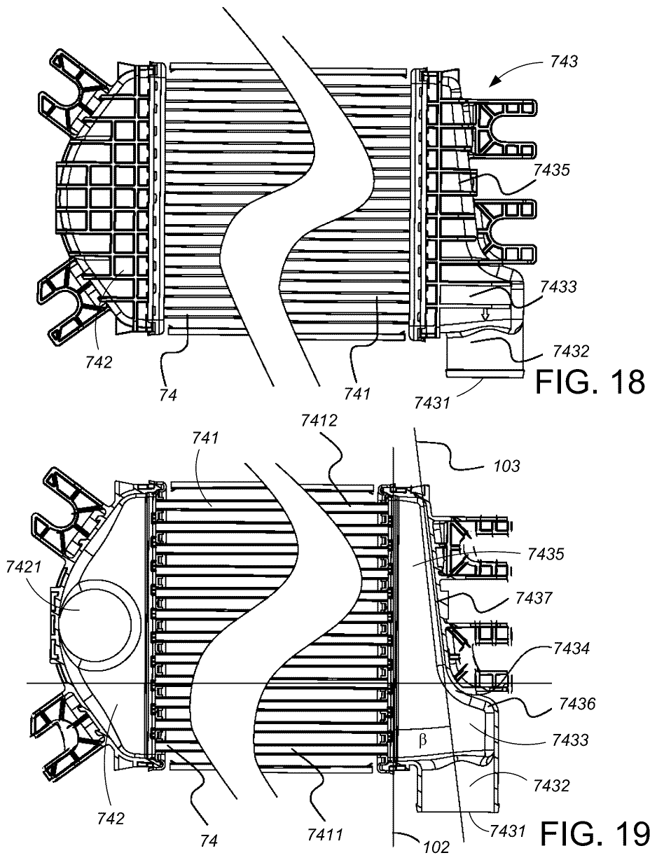

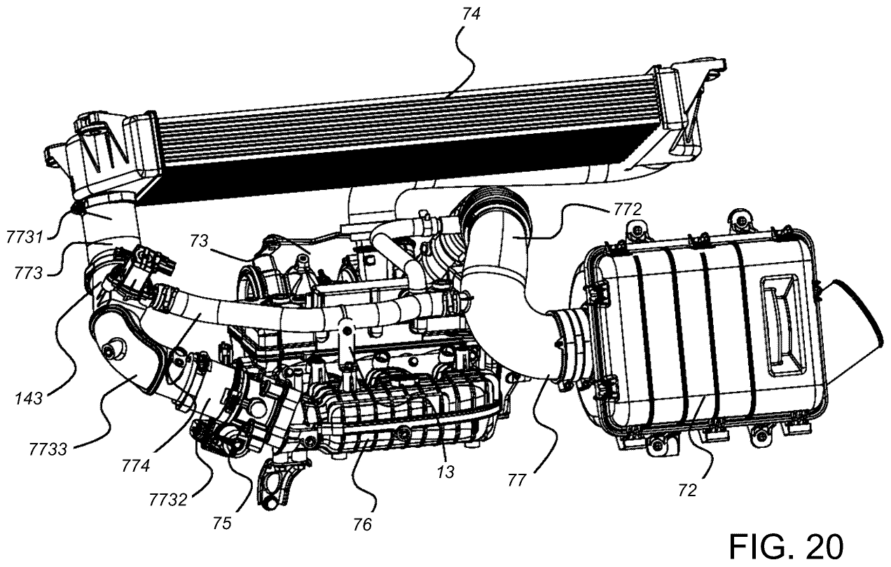

The intercooler 74 includes a plurality of pressurized air crosspipes 741, mounted so as to extend across the flow of ambient air for heat transfer from the pressurized air within the crosspipes 741 to the ambient air moving past. In the preferred layout, the intercooler 74 is mounted so the intercooler crosspipes 741 extend horizontally. FIGS. 2 and 26 show one mounting orientation of the intercooler 74 with horizontally-extending crosspipes 741, with a curved compressed air input end 742 on the left side of the ATV 100 and a slanted compressed air output end 743 on the right side of the ATV 100. FIGS. 18 and 19 show front views of a more preferred, alternative mounting orientation of the intercooler 74 with horizontally-extending crosspipes 741, with the slanted end 743 used as the compressed air input end on the left side of the ATV 100 and the curved end 742 used as the compressed air output end on the right side of the ATV 100.

The slanted input end 743 of the intercooler 74 has an intercooler input port 7431 on the bottom receiving compressed (and consequently heated) air from the turbocharger 73. The slanted input end 743 then includes an intake portion 7432, a full width transition portion 7433 with an input partial endwall 7434, and a tapering portion 7435, all preferably integrally formed for compressed airflow therethrough. The crosspipes 741 preferably all run parallel to each other, defining an intercooler crossplane 102 perpendicular to the direction of compressed airflow through the crosspipes 741. Some of the crosspipes 7411 are fluidly connected to the full width transition portion 7433 below the input partial endwall 7434, and some of the crosspipes 7412 are fluidly connected to the tapering portion 7435. In particular, preferably ⅕^{th} to ⅛^{th} of the total number of crosspipes 741 connect with the full width transition portion 7433 below the input partial endwall 7434, and more preferably ⅙^{th} to 1/7^{th} of the total number of crosspipes 741 connect with the full width transition portion below the input partial endwall 7434. The input partial endwall 7434 preferably has widely radiused corners 7436 rather than sharp corners, for smooth airflow.

The outer sidewall wall 7437 of the tapering portion 7435 extends along a tapering plane 103. An intercooler intake taper angle β between the tapering plane 103 and the intercooler crossplane 102 is an acute angle. The slanted input end 743 plays a guiding role in guiding the high-pressure air to enter the crosspipes 7412, so that the high-pressure air can smoothly enter the crosspipes 741, thereby reducing intercooler pressure loss so as to maximize turbocharger benefit. The intercooler intake angle β is preferably greater than or equal to 5° and less than or equal to 10°, more preferably greater than or equal to 6° and less than or equal to 9°, and most preferably greater than or equal to 7° and less than or equal to 8°. This layout of the full width transition portion 7433, the input partial endwall 7434 and the tapering portion 7435 makes it easier for air to enter the crosspipes 741 for more uniform air circulation through all of the crosspipes 741, improving the cooling efficiency of the intercooler 74.

he intake manifold 76 includes a manifold intake port 761, a central intake manifold chamber 762, and three cylinder head connection ports 763, one for each cylinder 141. The central intake manifold chamber 762 includes an entry extension portion 7621, which causes the length W2 of the central intake manifold chamber 762 to be greater than the total width W3 of the three cylinder head connection ports 763. This design of intake manifold 76 reduces airflow resistance during intermittent intake of the intake manifold 76, improving intake capacity of the engine 1.

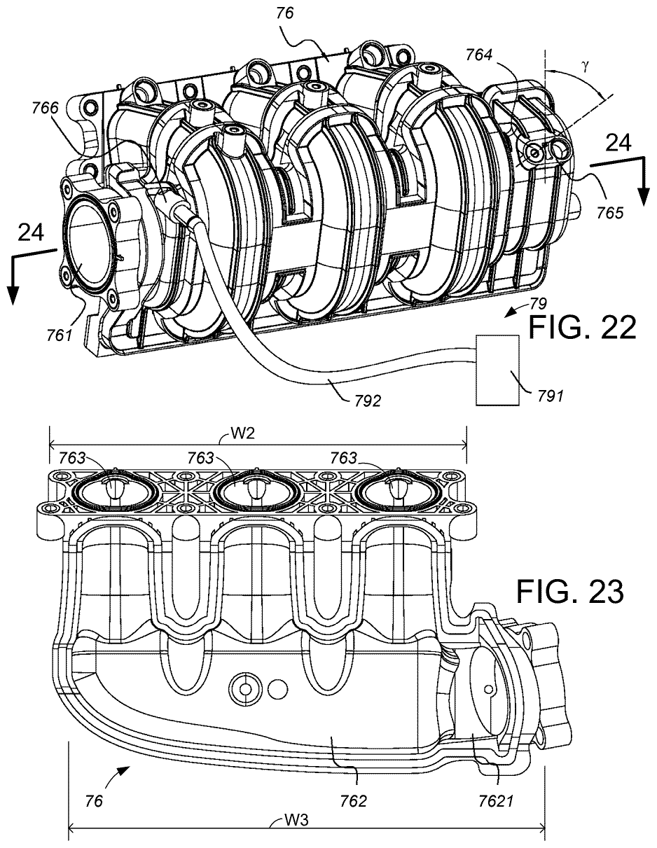

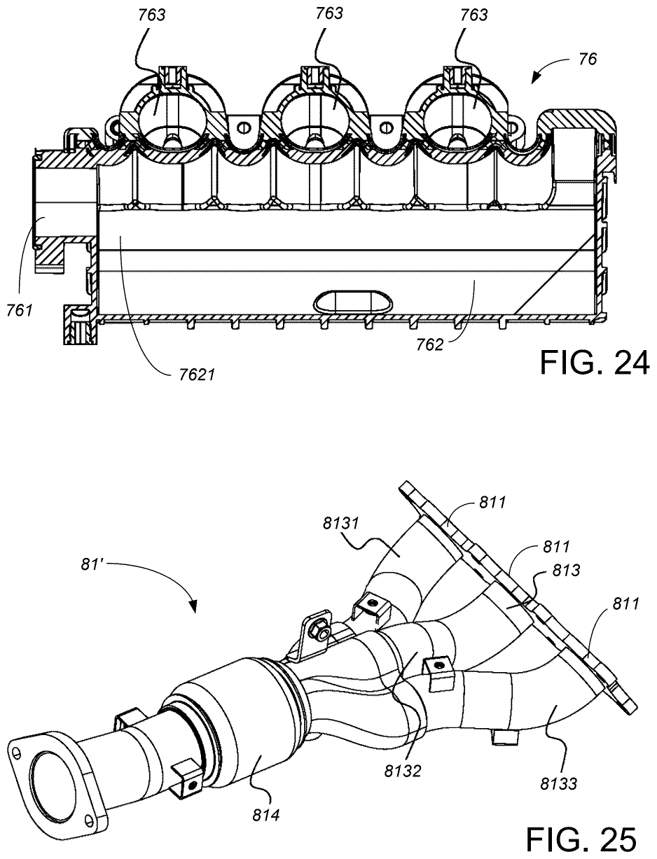

At least a portion of the intake manifold 76 protrudes outward to define a sensor mounting seat 764 shown only in FIG. 22, and a temperature/pressure sensor (not shown) is mounted on and fixedly connected to the mounting seat 764. The temperature/pressure sensor is used to detect the temperature and pressure of air in the central intake manifold chamber 762. The temperature/pressure sensor passes through the sensor mounting seat 764 to extend into the central intake manifold chamber 762. An extension direction 765 of the temperature/pressure sensor in the central intake manifold chamber 762 is at a sensor extension angle γ relative to vertical. The sensor extension angle γ is preferably greater than or equal to 40° and less than or equal to 50°, more preferably greater than or equal to 42° and less than or equal to 48°, and most preferably greater than or equal to 44° and less than or equal to 46°. An appropriate value for sensor extension angle γ reduces the influence of the intake manifold 76 on the temperature/pressure sensor, and improve the stability, accuracy, and reliability of the temperature/pressure sensor.

The preferred air intake system 7 includes a vapor recovery system 79 (shown only in FIG. 22) having a carbon canister 791 (shown schematically) connected to the intake manifold 76 through a vapor recovery port 766 in the entry extension portion 7621 of the intake manifold 76. A carbon canister pipeline 792 (shown schematically) connects the carbon canister 791 to the vapor recovery port 766 to transfer recovered fuel vapor from the carbon canister 791 to the intake manifold 76, where it is fully mixed in central intake manifold chamber 762 before flowing into cylinder head 13. Positioning the vapor recovery port 766 at the entry extension portion 7621 rather than closer to valves 171 in the cylinder head 13 leads to better mixing of the fuel vapor into the intake air stream and more complete combustion, avoiding carbon deposition within the engine block 14 due to insufficient combustion, improving the stability and service life of the engine 1.

Air pressure within the intake manifold 76 is high due to the turbocharger 73 and fluctuates rapidly as the engine 1 cycles. The wall thickness of the intake manifold 76 is preferably greater than or equal to 2 mm and less than or equal to 4 mm, more preferably greater than or equal to 2.5 mm and less than or equal to 3.5 mm.

The exhaust system 8 includes the exhaust manifold 81, 81′ and a muffler 83 connected by an exhaust pipe 84. An alternative embodiment of the exhaust manifold 81′ is shown in FIG. 25, for an engine embodiment that omits the turbocharger 73 and intercooler 74. The exhaust manifold 81′ includes three exhaust manifold ducts 813 (one for each cylinder 141) leading to a single corrugated exhaust manifold pipe 814. Despite the fact that there are different distances between the single corrugated exhaust pipe 814 and the exhaust intake ports 811, this exhaust manifold 81′ is configured so all the exhaust ducts 813 have the same length. Specifically, at least one of the exhaust manifold ducts 8132 is overly curved to take a less-than-direct route to the single corrugated exhaust manifold pipe 814, bending away from its extension direction and increasing its length to be equal to lengths of the other exhaust manifold ducts 8131, 8133. By have at least one exhaust manifold duct 8132 taking a less-than-direct route, it can be achieved that the lengths of the first exhaust manifold duct 8131, the second exhaust manifold duct 8132 and the third exhaust manifold duct 8133 are substantially the same. Thus, it can be ensured that the lengths of the flow paths of the exhaust gases when discharged from different combustion chambers 141 in the engine block 14 by the cylinder head 13 are substantially the same, making exhaust flow smoother and increasing exhaust efficiency.

The fact that the single exhaust manifold pipe 814 is corrugated helps effectively absorb vibration generated by exhaust pressure and flowrate fluctuations during engine running, increasing stability of the exhaust manifold 81′ and reducing fatigue and risk of fracture of the exhaust manifold 81′.

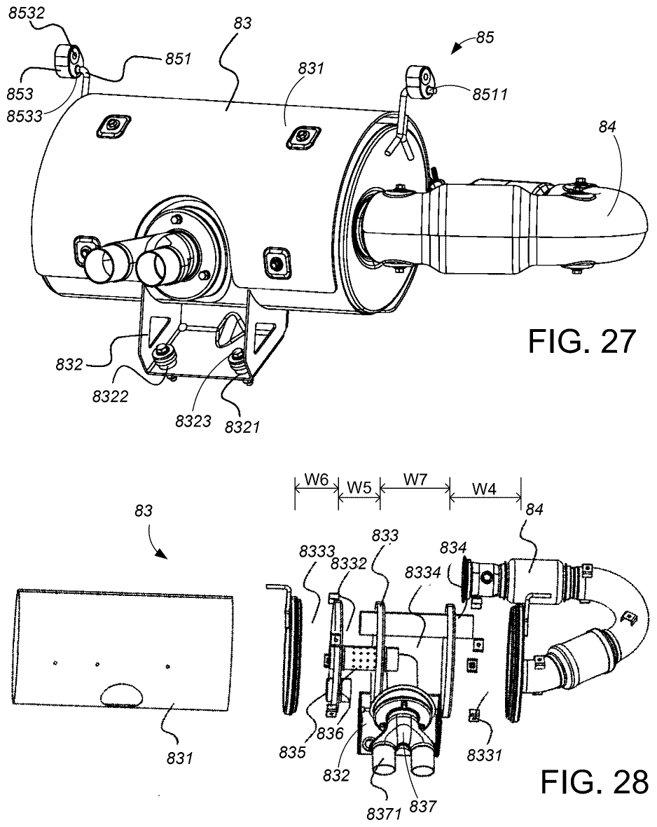

The preferred muffler 83 of the exhaust system 8 is shown in FIGS. 26 to 28. The muffler 83 is preferably hung from the frame 21 of the ATV 100 using two hangers 85. Each hanger 85 has generally rigid muffler hanger rod 851 secured to a muffler housing 831 of the muffler 83 such as by welding, a generally rigid frame hanger rod 852 secured to the frame 21 such as by welding, and an elastic connector block 853 preferably formed of rubber. The elastic connector block 853 includes a muffler rod through-hole 8531 and a frame rod through-hole 8532, both of which after assembly extend horizontally. Each of the hanger rods 851, 852 includes an insertion end 8511, 8521 which also extends horizontally. The insertion ends 8511, 8521 are inserted into the respective through-holes 8531, 8532 to hang the muffler 83 from the frame 21. The preferred insertion ends 8511, 8521 are configured as a circular truncated cone or a cone, which after assembly helps the elastic connector block 853 from separating off either of the hanger rods 851, 852. The elastic hanger blocks 853 buffer vibration between the frame 21 and the muffler 83, and the connection between the muffler 83 and the frame 21 is simple and convenient. At the same time, the hanger rods 851, 852 can slide relative to their elastic hanger block 853, so that the installation position of the muffler 83 can be adjusted according to the specific structure of the ATV 100, thereby making the muffler 83 more versatile.

The muffler 83 further includes a bottom support bracket 832 fixedly connected to the muffler housing 831 such as by welding. The lower end of the muffler 83 is relatively fixedly connected to the frame 21 by means of the bottom support bracket 832. The bottom support bracket 832 preferably includes two connection holes 8321, each with an elastic grommet 8322 positioned therein. For instance, the grommets 8322 may be formed of rubber, with an “I” shape that mates into the connection hole 8321. Bolts 8323 through the grommets 8322 connect the bottom support bracket 832 to the frame 21, while the grommets 8322 keep the bolts 8323 from directly contacting the bottom support bracket 832. The grommets 8322 buffer against vibration transmission between the muffler 83 and the frame 21, simultaneously reducing bolt wear.

The internal structure of the preferred muffler 83 is shown in FIG. 28. Three partitions 833 are provided inside the muffler housing 831, which divide the muffler 83 into an intro inner chamber 8331, an intermediate inner chamber 8332, an end inner chamber 8333, and an exit inner chamber 8334. The muffler 83 further includes a solid bypass pipe 834, a partition through pipe 835, a perforated bypass pipe 836 and a tailpipe 837. The solid bypass pipe 834 extends from the intro inner chamber 8331 to the intermediate inner chamber 8332. The perforated bypass pipe 836 extends from the end inner chamber 8333 to the exit inner chamber 8334. Exhaust from the exhaust pipe 84 first enters the intro inner chamber 8331. Exhaust then flows from the intro inner chamber 8331 to the intermediate inner chamber 8332 through the solid bypass pipe 834, from the intermediate inner chamber 8332 to the end inner chamber 8333 through the partition through pipe 835, from the end inner chamber 8333 to the exit inner chamber 8334 through the perforated bypass pipe 836, and out of the exit inner chamber 8334 through the tailpipe 837.

The wall thickness of the partitions 833 is preferably in the range of 1 to 2 mm. The width W4 of the intro inner chamber 8331 is preferably in the range from 125 to 145 mm. The width W5 of the intermediate inner chamber 8332 is preferably in the range from 90 to 110 mm. The width W6 of the end inner chamber 8333 is preferably in the range from 90 to 110 mm. The width W7 of the exit inner chamber 8334 is preferably in the range from 130 to 150 mm. An intro/exit ratio W4/W7 of the width W4 of the intro inner chamber 8331 to the width W7 of the exit inner chamber 8334 is preferably in the range from 0.6 to 1.2. An exit/intermediate ratio W7/W5 of the width W7 of the exit inner chamber 8333 to the width W2 of the intermediate inner chamber 8332 is preferably in the range from 1.2 to 1.8. An intermediate/end ratio W5/W6 of the width W5 of the intermediate inner chamber 8332 to the width W6 of the end inner chamber 8333 is preferably in the range from 0.6 to 1.2. The exhaust pipe 84 preferably has a diameter in the range from 65 to 70 mm. The solid bypass pipe 834, the partition through pipe 835 and the perforated bypass pipe 836 preferably each have a diameter in the range from 45 to 50 mm. The tailpipe 837 preferably has dual tailpipe sections 8371, each with a diameter in the range from 50 to 70 mm. Each of the exhaust pipe 84, the solid bypass pipe 834, the partition through pipe 835 and the perforated bypass pipe 836 preferably have a wall thickness in the range from 1 to 1.5 mm. The number of pores in the perforated bypass pipe 836 is preferably in the range from 30 to 50, and the diameter of pores is in the range from 2 to 5 mm. These dimensional ranges can improve the noise control of the ATV 100 while also ensuring smooth exhaust to maintain power and fuel economy of the engine 1.

It should be understood that for those skilled in the art, improvements or transformations can be made based on the above description, and all such improvements and transformations should fall within the scope of protection of the claims attached to this invention.

1. An all-terrain vehicle comprising:
a frame;
a body cover at least partially arranged on the frame;
four wheels supporting the frame;
a prime mover assembly supported on the frame and configured to drive the wheels to rotate for locomotion of the all-terrain vehicle, the prime mover assembly comprising an internal combustion engine;
an air intake system providing combustion air for the internal combustion engine, the air intake system comprising:
a turbocharger which pressurizes air, the pressurization causing air heating; and
an intercooler which cools pressurized air from the turbocharger and provides pressurized, cooled air for combustion, the intercooler having a plurality of pressurized air crosspipes defining an intercooler plane, wherein an intercooler attack angle of the intercooler plane relative to horizontal is greater than or equal to 80° and less than 90°.

2. The all-terrain vehicle of claim 1, wherein the body cover comprises a straddle seat, and wherein the intercooler is mounted above the engine.

3. The all-terrain vehicle of claim 1, wherein the air intake system comprises an intake pressure relief system, the intake pressure relief system comprising a pressure sensor and a pressure relief valve, wherein when the pressure sensor senses an onset of an overpressure event, the pressure relief valve is opened.

4. The all-terrain vehicle of claim 3, wherein the pressure relief valve is located downstream of the intercooler and upstream of a throttle assembly in fluid communication with a throttle duct, with a pressure relief duct connecting the pressure relief valve with a turbocharger air inlet duct.

5. The all-terrain vehicle of claim 4, wherein the throttle duct comprises a first flexible section, a load-bearing curved corner which helps support the pressure sensor and the pressure relief valve, and a second flexible section.

6. The all-terrain vehicle of claim 5, wherein the load-bearing curved corner is formed of hard plastic.

7. The all-terrain vehicle of claim 1, wherein the internal combustion engine has a plurality of cylinders, and further comprising an exhaust system with an exhaust manifold, wherein the turbocharger has a turbocharger housing with a turbine driven by exhaust from the internal combustion engine and a compressor within the turbocharger housing compressing air for combustion, wherein the turbocharger housing is integrally formed with the exhaust manifold.

8. The all-terrain vehicle of claim 7, wherein the exhaust manifold is bolted to a cylinder head, wherein the exhaust manifold comprises a plurality of exhaust intake ports, with flange gaps between the plurality of exhaust intake ports to allow thermal expansion difference between the cylinder head and the exhaust manifold.

9. The all-terrain vehicle of claim 8, wherein the flange gaps have a width greater than or equal to 3 mm and less than or equal to 5 mm.

10. The all-terrain vehicle of claim 1, wherein pressurized air is input on an input end of the intercooler, the input end having a tapering portion with an outer side wall defining a tapering plane, wherein the pressurized air crosspipes run parallel so as to define an intercooler crossplane perpendicular to a direction of compressed airflow through the pressurized air crosspipes, wherein an intercooler intake taper angle between the tapering plane and the intercooler crossplane is acute.

11. The all-terrain vehicle of claim 10, wherein the intercooler intake taper angle is greater than or equal to 5° and less than or equal to 10°.

12. The all-terrain vehicle of claim 10, wherein the input end further comprises a full width transition portion ending in an input partial endwall.

13. The all-terrain vehicle of claim 12, wherein ⅕^{th} to ⅛^{th} of a total number of pressurized air crosspipes connect with the full width transition portion below the input partial endwall.

14. The all-terrain vehicle of claim 1, wherein the internal combustion engine comprises an engine block with three cylinders, and with a knock sensor mounted on a knock sensor mounting seat on the engine block, the knock sensor mounting seat being located on a middle cylinder of the three cylinders at a mid-height of the engine block.

15. The all-terrain vehicle of claim 1, wherein the internal combustion engine comprises a cylinder head, and further comprising a lubrication system having an oil pump and an oil filter, with a head oil delivery passage defined in the cylinder head, and with an oil flowrate control bolt at least partially controlling oil flowrate through the head oil delivery passage.

16. The all-terrain vehicle of claim 1, wherein the internal combustion engine comprises an engine block with at least two cylinders, and further comprising a cooling system having a water pump, with a cylinder water jacket defined in the engine block, the cylinder water jacket having an intake side path and an exhaust side path, with at least one longitudinal coolant flow channel defined between the intake side path and the exhaust side path of the cylinder water jacket between cylinders.

17. The all-terrain vehicle of claim 16, wherein the longitudinal coolant flow channel is a groove in a top of the engine block, the groove having a channel width which is greater than or equal to 1 mm and less than or equal to 2 mm, the groove having a channel height which is greater than or equal to 3 mm and less than or equal to 7 mm.

18. An all-terrain vehicle comprising:
a frame;
a body cover at least partially arranged on the frame;
four wheels supporting the frame;
a prime mover assembly supported on the frame and configured to drive the wheels to rotate for locomotion of the all-terrain vehicle, the prime mover assembly comprising an internal combustion engine; and
an air intake system providing combustion air for the internal combustion engine, the air intake system comprising:
a turbocharger which pressurizes air, the pressurization causing air heating;
an intercooler which cools pressurized air from the turbocharger and provides pressurized, cooled air for combustion, the intercooler having a plurality of pressurized air crosspipes; and
an intake pressure relief system, the intake pressure relief system comprising a pressure sensor and a pressure relief valve, wherein when the pressure sensor senses an onset of an overpressure event, the pressure relief valve is opened.

19. The all-terrain vehicle of claim 18, wherein the pressure relief valve is located downstream of the intercooler and upstream of a throttle assembly in fluid communication with a throttle duct, with a pressure relief duct connecting the pressure relief valve with a turbocharger air inlet duct.

20. An all-terrain vehicle comprising:
a frame;
a body cover at least partially arranged on the frame;
four wheels supporting the frame;
a prime mover assembly supported on the frame and configured to drive the wheels to rotate for locomotion of the all-terrain vehicle, the prime mover assembly comprising an internal combustion engine with a plurality of cylinders and a cylinder head;
an air intake system providing combustion air for the internal combustion engine, the air intake system comprising:
a turbocharger which pressurizes air, the pressurization causing air heating, the turbocharger having a turbocharger housing with a turbine driven by exhaust from the internal combustion engine and a compressor within the turbocharger housing compressing air for combustion; and
an intercooler which cools pressurized air from the turbocharger and provides pressurized, cooled air for combustion, the intercooler having a plurality of pressurized air crosspipes; and
an exhaust system with an exhaust manifold, wherein the turbocharger housing is integrally formed with the exhaust manifold, wherein the exhaust manifold is bolted to the cylinder head, wherein the exhaust manifold comprises a plurality of exhaust intake ports, with flange gaps between the plurality of exhaust intake ports to allow thermal expansion difference between the cylinder head and the exhaust manifold.
